(19) United States
(12) Patent Application Publication
(10) Pub. No.: US 2014/0262919 A1
(43) Pub. Date: Sep. 18, 2014

(54) PASSIVELY ENABLE A BLISTER PACK WITH WIRELESS IDENTIFICATION DEVICE

(71) Applicant: MEPS Real-Time, Inc., Carlsbad, CA (US)

(72) Inventors: Shariq Hussain, Vista, CA (US); James P. Williams, JR., Carefree, AZ (US); Paul M. Elizondo, II, Escondido, CA (US)

(73) Assignee: MEPS REAL-TIME, INC., Carlsbad, CA (US)

(21) Appl. No.: 14/203,515

(22) Filed: Mar. 10, 2014

Related U.S. Application Data
(60) Provisional application No. 61/778,365, filed on Mar. 12, 2013.

(51) Int. Cl. A61J 1/03; B65B 3/02

(52) U.S. Cl. CPC A61J 1/035; B65B 3/022
USPC 206/534; 53/452

(57) ABSTRACT

A blister pack is provided having a wireless identification device located at a predetermined position. A moldable blister web is mounted with wireless identification devices at selected positions corresponding to the size of the blister components to be molded from the web. When a cavity is molded in the web in manufacturing a blister pack, the pre-mounted wireless identification device will be located at a predetermined position in the blister pack. In one embodiment, RFID devices are used as the wireless identification devices. The RFID device is pre-mounted on the blister web so that it will be located at a flat surface of the blister pack or on a rounded surface. The RFID devices are pre-mounted, and then the blister is molded to have a cavity, the product is inserted into the cavity and a sealing package component is attached to the blister cavity to seal it.

### CROSS-REFERENCES TO RELATED APPLICATIONS

This application claims the benefit of U.S. Provisional Application No. 61/778,365, filed Mar. 12, 2013, incorporated herein by reference.

### BACKGROUND

The present invention relates to packaging configurations, and in particular, to incorporating an RFID device in a blister pack to detect the package article and facilitate tracking the article.

Radio-frequency identification (“RFID”) is the use of electromagnetic energy (“EM energy”) to stimulate a responsive device (known as an RFID “tag,” “device,” or transponder) to identify itself and in some cases, provide additional stored data. RFID tags typically include a semiconductor device having a memory, circuitry, and one or more conductive traces that form an antenna. Typically, RFID tags act as transponders, providing information stored in the semiconductor device memory in response to an RF interrogation signal received from a reader, also referred to as an interrogator. Some RFID tags include security measures, such as passwords and/or encryption and some also permit information to be written or stored in the semiconductor memory via an RF signal.

RFID tags may be incorporated into or somehow physically associated with the articles to be tracked. In some cases, the tag may be attached to the outside of an article with adhesive, tape, or other means and in other cases, the tag may be located within the container of an article to be tracked. RFID tags are manufactured with a unique identification number which is typically a simple serial number of a few bytes with a check digit attached. This identification number or “string” is incorporated into the tag during manufacture. The user cannot alter this serial/identification number and manufacturers guarantee that each serial number is used only once. This configuration represents the low cost end of the technology in that the RFID tag is read-only and it responds to an interrogation signal only with its identification number. Typically, the tag continuously responds with its identification number. Data transmission to the tag is not possible. These tags are very low cost and are produced in enormous quantities.

In summary, RFID devices or “tags” are typically passive electrical devices, each of which includes a unique serial number. The RFID tag may also be programmed with other information if needed, such as product name, manufacturer name, date of manufacture, version no., and other information as desired.

Such read-only RFID tags typically are permanently attached to an article to be tracked and, once attached, the serial number of the tag is associated with its host article in a computer data base. For example, a particular type of medicine may be contained in hundreds or thousands of small vials. Upon manufacture, or receipt of the vials at a health care institution, an RFID tag is attached to each vial. Each vial with its permanently attached RFID tag will be checked into the data base of the health care institution upon receipt. The RFID identification number is associated in the data base with the type of medicine, size of the dose in the vial, and perhaps other information such as the expiration date of the medicine. Thereafter, when the RFID tag of a vial is interrogated and its identification number read, the data base of the health care institution can match that identification number with its stored data about the vial. The contents of the vial can then be determined as well as any other characteristics that have been stored in the data base such as expiration date, manufacturing date, and vendor name. This system requires that the institution maintain a comprehensive data base regarding the articles in inventory rather than incorporating such data into an RFID tag.

As used in regard to the embodiments herein, “reader” and “interrogator” refer to a device that may read or write/read. The data capture device is always referred to as a reader or an interrogator regardless of whether it can only read or is also capable of writing. A reader typically contains a radio frequency module (a transmitter and a receiver, sometimes referred to as a “transceiver”), a control unit and a coupling element (such as an antenna or antennae) to the RFID tag. Additionally, many readers include an interface for forwarding data elsewhere, such as by USB, Ethernet, wireless, and by an RS-232 interface. The reader, when transmitting, has an interrogation zone within which an RFID tag will be activated. When within the interrogation zone, the RFID tag will draw its power from the electrical/magnetic field created in the interrogation zone by the reader. In a sequential RFID system (SEQ), the interrogation field is switched off at regular intervals. The RFID tag is programmed to recognize these “off” gaps and they are used by the tag to send data, such as the tag's unique identification number. In some systems, the tag's data record contains a unique serial number that is incorporated when the tag is manufactured and which cannot be changed. This number may be associated in a data base with a particular article when the tag is attached to that article. Thus, determining the location of the tag will then result in determining the location of the article to which it is attached. In other systems, the RFID tag may contain more information about the article to which it is attached, such as the name or identification of the article, its expiration date, its dose, the patient name, and other information. The RFID tag may also be writable so that it can be updated.

An object of the tag is to associate it with an article throughout the article's life in a particular facility (such as a manufacturing facility), a transport vehicle, a health care facility, a storage area, home, or other, so that the article may be located, identified, and tracked, as it is moved. For example, knowing where certain medical articles reside at all times in a health care facility can greatly facilitate locating needed medical supplies when emergencies arise. Similarly, tracking the articles through the facility can assist in generating more efficient dispensing, inventory control systems, and compliance with applicable laws and regulations, as well as improving work flow in a facility and billing. Additionally, expiration dates can be monitored and those articles that are older and about to expire can be moved to the front of the line for immediate dispensing. This results in better inventory control and lowered costs. When recalls are issued by the manufacturer, this tracking system facilitates locating the recalled medical article.

Other RFID tags are writable and information about the article to which the RFID tag is attached can be programmed into the individual tag. While this can provide a distinct advantage when a facility's computer servers are unavailable, such tags cost more, depending on the size of the memory in the tag. Programming each one of the tags with information contained in the article to which they are attached can involve further expense and delay.

RFID tags may be applied to containers, packaging, or articles to be tracked by the manufacturer, the receiving party, or others. In some cases where a manufacturer applies the tags, the manufacturer will also supply an electronic data base file that links the identification number of each of the tags to the contents of each respective article. That manufacturer-supplied data base can be distributed to the customer in the form of a file that may easily be imported into the customer's overall data base thereby saving the customer from the expense of creating the data base itself.

Many RFID tags used today are passive in that they do not have a battery or other autonomous power supply and instead, must rely on the interrogating energy provided by an RFID reader to provide power to activate the tag. Passive RFID tags require an electromagnetic field of energy of a certain frequency range and certain minimum intensity in order to achieve activation of the tag and transmission of its stored data. Another choice is an active RFID tag as mentioned above; however, such tags require an accompanying battery to provide power to activate the tag, thus increasing the expense of the tag and making them undesirable for use in a large number of applications.

The subject invention is directed to a “blister pack” which comprises a backing and a clear plastic cover, with the plastic cover in some cases having a shape conformed to the particular product sealed in the pack. The backing material may comprise metal foil, cardboard, aluminum foil, plastic, or other materials or combinations of materials. For the purposes of this invention, the shape of the plastic cover is immaterial. The term “blister pack” typically refers to non-reclosable, typically clear plastic packaging commonly used for unit-dose packaging for pharmaceutical dosage forms such as tablets, capsules, or lozenges. An example is shown in FIG. 1 in which the blister pack 50 has “tablet” type pills 52 packaged in individual form. Blister packs provide a degree of protection where product tampering is a consideration by way of product/packaging integrity. In the United States, blister packs are mainly used for packing physician samples of drug products or for the sale of Over the Counter (“OTC”) products in the pharmacy. Blister packs can provide barrier protection for shelf life requirements and a degree of tamper resistance and are useful for protecting the product against external factors such as humidity and contamination for extended periods of time. Opaque blisters also protect sensitive products against daylight. In other parts of the world, blister packs are the main packaging type since pharmacy dispensing and re-packaging are not common.

A series of blister cavities 54, such as that shown in FIG. 1, is sometimes called a “blister card” or “blister strip” as well as blister pack. The difference between a strip pack and a blister pack is that a strip pack does not have thermo-formed or cold formed cavities; the strip pack is formed around the tablet at a time when it is dropped to the sealing area between sealing molds. In this example, the thermoplastic film 56 is formed into cavities 54 in which the tablets 52 are held. The thermoplastic film is then mounted to a base web 60 which can comprise one or more layers, such as aluminum foil and a paper layer.

In some parts of the world the pharmaceutical blister pack is known as a Push-Through-Pack (PTP) which as two key properties: (i) the lidding foil 60 (base layer) is brittle allowing a user to press against the cavity and product to press the product out of the blister pack by breaking the lidding foil (also referred to as “erupting foil” and freeing the product by “erupting” it through the foil); and (ii) a semi-rigid formed cavity 54 being sufficiently collapsible so that the user can press the product through the lidding or erupting foil to be able to dispense the tablet or capsule by means of pressing it out with the thumb. The main advantages of unit-dose blister packs over other methods of packing pharmaceutical products are the assurance of product/packaging integrity (including shelf life) of each individual dose and the possibility to create a compliance pack or calendar pack by printing the days of the week above each dose.

Blister packs are created by means of a form-fill-seal process at the pharmaceutical company or designated contract packer. A form-fill-seal process means that the blister pack is created from rolls of flat sheet or thermoplastic film, filled with the pharmaceutical product and closed (sealed) with the base web on the same equipment. Such equipment is called a blisterline. Blister packs include two principle components: (1) a formed base which includes the cavities inside which the products fit, and (2) a sealing rupture foil or film (made of, for example, an aluminum foil) which covers the cavities for dispensing the product out of the pack. The blister pack may also include a plastic or paper foil disposed over the sealing foil wherein the attachment between the plastic or paper foil and the sealing foil is stronger that the attachment between the sealing foil and the base so that a portion of the sealing foil (i.e., covering one of the cavities) may be removed as desired.

Medical blister trays differ from pharmaceutical blister packs in that these are not push-through packs. The thermoformed base web is made of a thicker plastic sheet, generally between 500μ to 1000μ and can not be collapsed, thus forming a solid tray. The lidding film provides a peel-open feature and is generally porous to allow sterilization (such as the Dupont medical Tyvek® material). Such medical blister packs are used for medical articles.

In the case of thermoforming, a plastic film or sheet is unwound from the reel and guided though pre-heating station on the blister line. The temperature of the pre-heating plates (upper and lower plates) is such that the plastic will soften and become pliable. The warm plastic will then arrive in a forming station where a large pressure (4 to 8 bars) will form the blister cavity into a negative mold. The mold is cooled such that the plastic becomes rigid again and maintains its shape when removed from the mold. In case of difficult shapes, the warm film will be physically pushed down partially into the cavity by a “plug-assist” feature. Plug-assist results in a blister cavity with more uniform wall distribution and is typically used when the cavity size and shape is larger than a small tablets and capsules.

In the case of cold forming, an aluminum-based laminate film is simply pressed into a mold by means of a stamp. The aluminum will be elongated and maintain the formed shape. In the industry these blisters are called cold form foil (CFF) blisters. The principal advantage of cold form foil blisters is that the use of aluminum offers a near complete barrier for water and oxygen, allowing an extended product expiry date. The principal disadvantages of cold form foil blisters are: the slower speed of production compared to thermoforming; the lack of transparency of the package (a therapy compliance disadvantage); and the larger size of the blister card (aluminum can not be formed with near 90 degree angles).

As discussed, the primary component of a blister pack is a cavity or pocket made from a formable web, usually a thermoformed plastic. This usually has a backing formed of a base web. A blister that folds onto itself is often called a clamshell package. Other types of blister packs consist of carded packaging where goods such as toys, hardware, and electrical items are contained between a specially made paperboard card and clear pre-formed plastic such as PVC. The consumer can visually examine the product through the transparent plastic. The plastic shell is vacuum-formed around a mold so it can contain the item snugly. The card is colored and designed depending on the item inside, and the PVC is affixed to the card using heat and pressure to activate an adhesive (heat seal coating) on the blister card. The adhesive is strong enough so that the pack may hang on a peg, but weak enough so that the package can be easily opened (in theory). Sometimes, with large items, the card has a perforated window for access.

Key concerns with blister packs that are used in the pharmaceutical industry are tampering and counterfeiting. In particular, with counterfeiting, a counterfeiter may try to open the blister pack and replace the original product with a counterfeit product, or may try to duplicate the blister pack in its entirety. To address these concerns among others, the FDA will likely require chain of custody tracking for a variety of pharmaceutical products. There is thus a need for techniques for improving the ability to detect and prevent tampering and counterfeiting and facilitating chain of custody tracking in situations where blister packs are employed.

An RFID inlay comprises a chip and an antenna (made of aluminum, copper, or silver) bonded to a polyethylene terephthalate (PET) layer. Inlays are generally laminated or “converted” by companies that place them between a paper face sheet and pressure sensitive adhesive. Such inlays are attached to articles or packaging of the articles by pressing them onto the article or packaging.

Another concern is the future requirements of some jurisdictions for ePedigree measures. “Pedigree” means a record, in electronic form, containing information regarding each transaction resulting in a change of ownership of a given dangerous drug, from sale by a manufacturer, through acquisition and sale by one or more wholesalers, manufacturers, or pharmacies, until final sale to a pharmacy or other person furnishing, administering, or dispensing the dangerous drug. The pedigree shall be created and maintained in an interoperable electronic system, ensuring compatibility throughout all stages of distribution.” A counterfeit is not always a fake or altered medication. It could also be stolen medication but repackaged. A system under discussion will also provide Pedigree on the packaging material. Such a system is scheduled for year 2015 in California and may be implemented elsewhere in the future. An efficient, low cost, and accurate way to track medical articles from production to dispensing is a need identified in the art.

Currently to provide RFID identification to a product, the manufacturer introduces an external process of applying an RFID tag inlay to the blister pack once the blister has been formed. This takes time and effort and slows down the manufacturing process, as well as adding expense. The current process of RFID-inlay application requires the change or addition of hardware to the packaging line. For a pharmaceutical company, such an addition or change could have Federal Drug Administration (“FDA”) regulatory effects, which is undesirable.

Hence, those of skill in the art have recognized a need for a system and method to track medical articles from first packaging through dispensing. The addition of a mandated ePedigree system has also created a need for a low-cost, accurate, and reliable system of tracking medical articles. The present invention fulfills these needs and others.

### SUMMARY OF THE INVENTION

Briefly and in general terms, the present invention is directed to a system and method for enabling a blister pack with a wireless identification device that was pre-mounted to the blister material web prior to forming the blister pack. In more detailed terms, there is provided a blister pack for packaging and wirelessly identifying a medical article, the blister pack comprising a first package component having an outer size and comprising a cavity with a cavity opening, the cavity and cavity opening configured to accept a medical article for packaging, wherein the first package component is formed from a continuous web of formable blister material to which wireless identification devices have been pre-mounted in predetermined positions prior to molding a cavity for the first package component and separating the first package component from the formable blister web, the locations for pre-mounting the wireless identification devices to the continuous moldable blister web having been selected based on the outer size of the first package component and a predetermined position for the wireless identification devices in relation to a medical article being received by each cavity so that when first package components are separated from the moldable blister web, the pre-mounted wireless identification devices are each located in a predetermined position in relation to the cavity and a second package component attached to the first package component to seal the cavity opening, thereby packaging a medical article in a blister pack.

In more detailed aspects, the cavity of the first package component was thermoformed into the moldable blister web. In another aspect, the cavity of the first package component was cold formed into the moldable blister web. The second package component includes a second cavity formed from a second moldable blister web in which no wireless identification devices have been pre-mounted, the second cavity also configured to accept a medical device such that when the first and second package components are assembled together, a clam shell blister pack is formed in which is packaged a medical article.

In yet further more detailed aspects, the pre-mounted wireless identification device comprises an RFID device having a preprogrammed identification string. The RFID device is passive with no autonomous power source. The RFID device comprises an inlay of an RFID circuit device and an RFID antenna deposit, in which the RFID antenna is deposited onto the moldable blister web first and then the RFID circuit device is physically and electrically joined to the pre-deposited RFID antenna to complete the wireless identification device on the moldable blister web.

In yet other aspects, the second package component of the blister pack comprises a waterproof layer that is sealed to the first package component whereby the blister pack is waterproof. The second package component comprises an eruptible foil section aligned with the cavity opening and having a limited retention strength that may be overcome by pressing an outer surface of the cavity of the first package component adjacent the packaged medical article in the cavity thereby pushing the medical article out of the cavity and erupting it through the eruptible foil section to remove the medical article from the packaging.

In accordance with method aspects of the invention, there is provided a method for packaging and wirelessly identifying a medical article in a blister pack, the method comprising forming a first package component from a continuous blister web of formable material to which wireless identification devices have been pre-mounted in predetermined positions by molding a cavity and cavity opening and separating the first package component from the moldable blister web such that it has an predetermined outer size, wherein the cavity and cavity opening are configured to accept a medical article for packaging, and wherein the step of forming further comprises molding the cavity and cavity opening such that the pre-mounted wireless identification device for the formed first package component will have a predetermined position in relation to a medical article packaged in the cavity, and forming a second package component, and attaching the second package component to the first package component to seal the cavity opening, thereby packaging a medical article in a blister pack.

In more detailed method aspects, the step of molding the cavity comprises thermoforming the cavity from the moldable blister web. The step of molding the cavity comprises cold forming the cavity from the moldable blister web. The step of forming a second package component comprises forming a second cavity from a second moldable blister web of material in which no wireless identification devices have been pre-mounted, the second cavity being configured to accept a medical device such that when assembled, the first and second package components of the blister pack form a clam shell package about a medical article.

In yet other aspects, there is provided a method for forming a web of blister packaging and wirelessly identifying material for use in forming blister packs about medical articles that also provide an identification device, the method comprising depositing a series of spaced-apart identification antenna traces along a length of a moldable blister web of packaging material, the blister web having a width and length selected to support the manufacture of an order for multiple blister packs for medical articles, the location of the identification antenna traces selected so that when the blister web is formed into blister packs, each identification antenna trace will be located in a predetermined position in relation to a reference point on the blister pack formed from the blister web, mounting a wireless identification circuit device in electrical contact with each of the antenna traces on the moldable blister web of packaging material to form complete wireless identification devices at each location, and storing the blister web of blister packaging and wirelessly identifying material in a configuration useful for storing, transporting, and manufacturing.

In more detailed aspects, the steps of depositing antenna traces and mounting a wireless identification circuit at each antenna trace comprises depositing RFID antenna traces and mounting RFID identification circuits.

The features and advantages of the invention will be more readily understood from the following detailed description that should be read in conjunction with the accompanying drawings.

### BRIEF DESCRIPTION OF THE DRAWINGS

FIG. 1 presents a prior art blister pack used with tablets;

FIG. 2 is a perspective view of a medical article that is often manufactured with a blister pack packaging, transported, stocked, and handled with a blister pack protection;

FIG. 3 is an exploded view of a blister pack used with the medical article of FIG. 2;

FIG. 4 is a cross-section view of the blister portion of the blister pack of FIG. 3;

FIG. 5 shows the first step in one embodiment of mounting a wireless identification device to a blister web in which and RFID antenna is inked to the web;

FIG. 6 shows a second step in completing the mounting of an RFID tag in a predetermined location on the blister web, in which the RFID circuit is electrically connected with the antenna formed in FIG. 5;

FIG. 7 is a view of a roll of a blister web that has had a series of RFID tags pre-mounted to the web before each portion of the web is processed into a blister for a blister pack;

FIG. 8 shows a schematic of a manufacturing line in which the RFID tags are mounted to the blister web at predetermined locations; and

FIG. 9 shows a schematic of a manufacturing line in which the blister web is molded into cavities, the cavities receive a medical article, a sealing backing or component is put over the cavity openings and the individual blister packs are separated by the web.

### DETAILED DESCRIPTION OF THE PREFERRED EMBODIMENTS

Referring now in more detail to the drawings for purposes of illustrating embodiments of the invention, wherein like reference numerals designate corresponding or like elements among the several views, there is shown in FIG. 1 a diagram of an existing blister pack 50 for tablets 52. In accordance with aspects of the present invention, the basic blister pack elements are used; i.e., a moldable blister web from which the blister 56 having a cavity or cavities 54 is formed. A sealing component 60 is attached to the blister 56 and seals the cavities at the openings of the cavities. However in the diagram of FIG. 1, there is no wireless identification device for all or any of the tablets 52. Under the present available systems, a wireless identification device would need to be added to the pack 50 that is shown. As discussed above, this additional step of adding an identification device has disadvantages, one of which being the requirement for an extra manufacturing step. Currently, to provide RFID identification to a product, the manufacturer introduces an external process of applying an RFID tag inlay to the blister pack once the blister pack has been formed. This takes time and effort and slows down the manufacturing process, as well as adding expense.

As used herein, a “web” or “continuous web” of material is a long length of material typically reeled up in a roll, that usually applies to paper, cardboard, or other woven goods, and is also meant to refer to plastics, bio-degradable material, and other materials used in the formation of a blister back, whether or not those materials are woven. When referring to thermoplastic, bio-degradable material, or other non-textile, paper, cardboard, or similar material, a long continuous length may be referred to as a “web” or “continuous web” for convenience or a “continuous sheet,” both of which are referring to lengths so long that the material is typically stored and handled in rolls. Bio-degradable materials refer to many presently developed and those that will be developed in the future. Examples are plasticized wheat starch (PWS) with bio-degradable polyesters, or PWS with cellulose fibers composites.

A need has been recognized for packaging most medical articles for sterility and safety and blister packs are used very often. Additionally, a need has been recognized for associating a wireless identification device with medications and other medical articles so that they can be tracked from manufacture to dispensing. “Add-on” identification devices are undesirable and an improved system and method are needed. In accordance with the invention, a blister pack having a wireless identification device, such as an RFID device, built-in and strategically placed for a respective blister pack forming process would fulfill these needs. The same need has arisen for other types of packaging. By introducing this process of pre-installed or pre-printed RFID inlays on a plastic roll, pharmaceutical companies can still thermoform the product as they would do normally. But the pharmaceutical company will now have the RFID capability already on the packaging itself. The invention provides pre- and post-thermoforming RFID capability that can be utilized in inventory control from the manufacture of raw roll stock to the final product in the field.

The present invention is suitable for flexible multi-pocketed re-sealable packages, prescription medications, medical supply kits, and is equally well suited for non-prescription, over-the-counter medications. Usefulness is also found for dietary supplements, medical and surgical supplies, parts, food products, kits, and various other items.

Instead of using the prior art stock plastic roll, the invention furnishes the ability to procure a plastic roll of the same size and characteristics as the stock roll but with wireless inlays, such as RFID-inlays, already built-in. The placement of RFID-inlays will be pre-determined by the characteristics of the blister pack. Ideally, if a particular blister pack has a flat surface, the RFID-inlay would reside on that flat surface. In the absence of a flat surface, an RFID-inlay could curve around an edge.

RFID-inlays can be printed or etched on the plastic to be used for packaging in two different steps. Once the placement area or areas and size of an RFID-inlay are determined, an antenna or antennae are screened in the desired area. After curing the antennae, a module or device containing an RFID silicon chip (also referred to as a “circuit”) will be coupled with each antenna. The chip will have pre-programmed information such as the identification of the RFID tag, a product code, and possibly other information, to conform to any International Organization for Standardization(“ISO”) and/or electronic product code (“EPC”) standards.

Blister web material can take many forms, some of which are a flexible sheet material such a thermoplastic material (polyethylene, polypropylene, etc.) as well as other suitable flexible sheet material.

The subject invention is directed to a “blister pack” which, in one embodiment, comprises a cardboard backing and a clear plastic cover, with the plastic cover in some cases having a shape conformed to the particular product sealed in the pack. For the purposes of this invention, the shape of the plastic cover is immaterial. Referring now to FIG. 2, there is shown a medical article, in this case a pre-loaded syringe 70 having a cannula cover 72. Such medical articles are often protected by blister packs.

Proceeding on now to FIG. 3, there is shown an exemplary blister pack 80 in accordance with aspects of the invention that is similar to one that may be used for the medical syringe article 70 shown in FIG. 2. In the blister pack of FIG. 3, a blister 82 of clear plastic has been molded with a cavity 84 having a shape configured to receive the syringe of FIG. 2. FIG. 4 shows a cross-sectional view of part of FIG. 3 showing the cavity 84 more clearly and the cavity opening 86. In this case, the blister is also formed with a flange 88 which may be used for mounting to the sealing component 96. The sealing component can take many forms, such as paper, cardboard, plastic, aluminum, and other materials. In this embodiment, the blister 82 is attached to the sealing component by means of adhesive 98. In the case where the blister pack is to be waterproof, all components, including the adhesive, should be formed of waterproof materials. In this embodiment, the sealing component also has writing 100 on its upper surface 102 that may be read through the clear blister 82.

Also shown in FIG. 3 is a wireless identification device 110. In this case, it is formed as part of the blister 82 and is located in a rounded portion of the blister. In this embodiment, an RFID device is used as the wireless identification device. The RFID device includes a serial number that it transmits when interrogated by a reader. It does not have an autonomous power source and derives its power from an interrogation signal, as was described at length in the background section. In accordance with an aspect of the invention, the RFID device 110 was mounted to the blister web prior to molding the blister into the shape shown in FIG. 3. Because it was part of the blister web, no additional step is needed to add a wireless identification device later. In the case where the RFID device is mounted within the cavity, it can be seen through the clear blister. In many cases, the packager will select the appropriate location for the RFID tag so as to not visually block important information concerning the blister-packed medical article.

Now referring to FIGS. 5 and 6, a portion of a blister web 120 is shown. In FIG. 5, an antenna 122 has been inked onto the blister web. The leads 124 and 126 of the antenna are available for electrical connection to an RFID circuit 130, which is shown in FIG. 6. The RFID circuit 130 is physically connected with the antenna and/or the web by means well known to those skilled in the art. FIG. 6 thus shows a complete wireless identification device that, in accordance with inventive aspects, is pre-mounted to the blister web prior to molding.

Turning to FIG. 7, a roll 140 of blister web in accordance with aspects of the invention is shown. As mentioned earlier, a blister web is a lengthy sheet of a plastic material or other material usable for the blister in a blister pack. In this case, the sheet is so long that it has been reeled into a roll form for easier storage, handling, and manufacturing. During manufacturing of the blister web 140 shown in FIG. 7, RFID tags were mounted at predetermined locations based on the desired final position of the RFID tag on the blister after the particular segment 146 of the blister web 140 has been formed into the actual blister 82 (see FIG. 3) for the of the blister pack. In this embodiment, RFID tags have been mounted to the web along its entire length.

The blister web 140 appears to have a plurality of segments indicated each of which includes an RFID tag. An end 142 is shown with seven pre-mounted wireless identification devices 144 in separate sections of the web. Such indication of segmentation may or may not be needed or exist in another embodiment. In this case, the segmentation indicates the approximate size of the final blister once the segment has been molded as shown in FIG. 3, and separated from the blister web 140. In this case, the RFID tags are passive in nature and do not include an autonomous power source.

FIG. 8 presents a schematic view of a manufacturing process to prepare a passively enabled blister pack web with a wireless identification device. A roll of blister web 150 is shown and is being pulled in the direction shown by the arrow. At the first station 152, the antenna or antennae are inked to the blister web. At the second station 154, the RFID circuit is mounted to the web and electrically connected to the antenna or antennae. The passively enabled blister pack web is then reeled into a roll 156.

FIG. 9 presents a schematic view of forming the passively enabled blister pack web with a wireless identification device into individual blister packs. Starting at the left side, the enabled blister web 156 is unrolled and pulled in the direction shown by the arrow. At the first station 162, a cavity is molded into the web. At the next station 164, a medical article, such as syringe 70 (FIG. 2) is inserted into the cavity. In this case the existence of an inserted medical article is indicated by cross-hatching. A roll of the sealing component 168, which may be paper, cardboard, plastic, or other material, is unrolled and applied to the cavity openings of the molded blister cavities, approximately at position 170. Rollers are likely used and adhesive applied but these steps have been excluded from FIG. 9 so that clarity of the method can be seen. At the end of the run 172, the completed blister pack with medical article inside is separated from the web 156. Details of separating the completed blister packs have also been excluded as have many other manufacturing devices so that clarity of the drawing is preserved.

In accordance with the invention therefore, a process is provided in which plastic roll stock will have RFID tag inlays built in and strategically placed for the respective blister forming process. The current process of RFID tag inlay application requires a change or addition of hardware to the packaging line. For a pharmaceutical company, adding such an RFID tag after the manufacture and packaging of a product could make it subject to further FDA requirements, which is an undesirable situation. By introducing the invention of pre-installed/printed inlays on a plastic roll, pharmaceutical companies can still thermoform the product as they would normally do. But they will then have the added RFID capability already on the packaging itself. The invention thus provides pre- and post-thermoforming RFID capability that can be utilized in inventory control from the manufacture of raw plastic roll stock to the final product in the field. The RFID tag can be programmed before manufacture of the blister or after.

Instead of a stock plastic roll from which pharmaceutical companies manufacture thermoformed blister packs, the pharmaceutical company will procure a plastic roll of the same size and characteristics but with RFID tag inlays already built in. The placement of the RFID tag inlays will be predetermined by the characteristics of the blister pack to be formed from the plastic. Ideally, if a particular blister pack has a flat surface, the RFID tag inlay would reside on that surface. In the absence of a flat surface, an inlay could curve around an edge. This is not a disadvantage since RFID tags operate electrically and their viewable position is usually irrelevant to their operation.

The RFID tag inlays will be printed or etched on the plastic in two different steps. Once the placement areas and size of an RFID tag inlay are determined, an antenna is screened in the desired area. After curing the antenna, a module containing an RFID silicon chip will be coupled with each antenna as was schematically shown in FIG. 8. The chip will have pre-programmed information like a tag identification number, product code, etc., to conform to any ISO and or European product code standards.

Pharmaceutical companies will not need to change their packaging processes. They can continue to thermoform the plastic as they currently do but with the added capability of having RFID tags already placed on the packaging where desired. With the new E-Pedigree Law measures that will be in place for year 2015 in California, the invention will allow pharmaceutical companies to more easily meet the requirements. The disclosed system and method can also be used to provide a Pedigree or e-Pedigree on the packaging material.

It should be noted that aspects of the invention may be applicable to certain size sheets that can be stacked in line before a molding process forms a cavity in them. A wireless identification device can be pre-mounted in each sheet before the molding process occurs, as is done with the continuous web described above.

Although RFID devices are discussed and shown in the drawings and text, other wireless identification technologies may also be useful. For example, an optical system in which a bar code is used may also function well. The bar code would be attached or embedded in the blister prior to its being molded. In the bar code approach, large angles must be avoided for mounting the bar code. Otherwise the reader may miss portions of the bar code when reading it.

As used herein, “RFID” chip, tag, or device is one wireless embodiment of the invention. Other wireless information or identification devices now in existence or to become available in the future may also suffice. Such wireless identification devices may take different forms and yet still function in the invention. An identification “string” is meant to refer to the typical RFID identification serial number, but can also refer to other forms of identification codes, such as a series of numbers and letters, or other.

Unless the context requires otherwise, throughout the specification and claims that follow, the word “comprise” and variations thereof, such as, “comprises” and “comprising” are to be construed in an open, inclusive sense, which is as “including, but not limited to.”

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the spirit and scope of the appended claims.

What is claimed is:

1. A blister pack for packaging and wirelessly identifying a medical article, the blister pack comprising:
a first package component having an outer size and comprising a cavity with a cavity opening, the cavity and cavity opening configured to accept a medical article for packaging, wherein the first package component is formed from a continuous web of formable blister material to which wireless identification devices have been pre-mounted in predetermined positions prior to molding a cavity for the first package component and separating the first package component from the formable blister web, the locations for pre-mounting the wireless identification devices to the continuous moldable blister web having been selected based on the outer size of the first package component and a predetermined position for the wireless identification devices in relation to a medical article being received by each cavity so that when first package components are separated from the moldable blister web, the pre-mounted wireless identification devices are each located in a predetermined position in relation to the cavity; and
a second package component attached to the first package component to seal the cavity opening, thereby packaging a medical article in a blister pack.

2. The blister pack for packaging and wirelessly identifying a medical article of claim 1, wherein the cavity of the first package component was thermoformed into the moldable blister web.

3. The blister pack for packaging and wirelessly identifying a medical article of claim 1, wherein the cavity of the first package component was cold formed into the moldable blister web.

4. The blister pack for packaging and wirelessly identifying a medical article of claim 1, wherein the second package component includes a second cavity formed from a second moldable blister web in which no wireless identification devices have been pre-mounted, the second cavity also configured to accept a medical device such that when the first and second package components are assembled together, a clam shell blister pack is formed in which is packaged a medical article.

5. The blister pack for packaging and wirelessly identifying a medical article of claim 1, wherein the pre-mounted wireless identification device comprises an RFID device having a preprogrammed identification string.

6. The blister pack for packaging and wirelessly identifying a medical article of claim 5, wherein the RFID device is passive with no autonomous power source.

7. The blister pack for packaging and wirelessly identifying a medical article of claim 5, wherein the RFID device comprises an inlay of an RFID circuit device and an RFID antenna deposit, in which the RFID antenna is deposited onto the moldable blister web first and then the RFID circuit device is physically and electrically joined to the pre-deposited RFID antenna to complete the wireless identification device on the moldable blister web.

8. The blister pack for packaging and wirelessly identifying a medical article of claim 1, wherein the second package component of the blister pack comprises a waterproof layer that is sealed to the first package component whereby the blister pack is waterproof.

9. The blister pack for packaging and wirelessly identifying a medical article of claim 1, wherein the second package component comprises an eruptible foil section aligned with the cavity opening and having a limited retention strength that may be overcome by pressing an outer surface of the cavity of the first package component adjacent the packaged medical article in the cavity thereby pushing the medical article out of the cavity and erupting it through the eruptible foil section to remove the medical article from the packaging.

10. A blister pack for packaging and wirelessly identifying a medical article, the blister pack comprising:
a first package component having an outer size and comprising a cavity with a cavity opening, the cavity and cavity opening configured to accept a medical article for packaging, wherein the first portion is thermoformed from a continuous blister web of formable material to which RFID devices have been pre-mounted in predetermined positions prior to molding a cavity for the first package component and separating the first package component from the moldable blister web, the locations for pre-attaching the RFID devices to the continuous moldable blister web having been selected based on the outer size of the first package component and a predetermined position for the wireless identification devices in relation to a medical article being received by each cavity so that when first package components are separated from the moldable blister web, the pre-mounted RFID devices are each located in a predetermined position in relation to the cavity; and
a second package component attached to the first package component to seal the cavity opening, thereby packaging a medical article in a blister pack.
wherein the RFID device has a preprogrammed identification string with no autonomous power source.

11. The blister pack for packaging and wirelessly identifying a medical article of claim 10, wherein the second package component of the blister pack comprises a waterproof layer that is sealed to the first package component whereby the blister pack is waterproof.

12. The blister pack for packaging and wirelessly identifying a medical article of claim 10, wherein the second package component comprises an eruptible foil section aligned with the cavity opening and having a limited retention strength that may be overcome by pressing an outer surface of the first package component adjacent the packaged medical article in the cavity thereby pushing the medical article out of the cavity and erupting it through the eruptible foil section to remove the medical article from the packaging.

13. A method for packaging and wirelessly identifying a medical article in a blister pack, the method comprising:
forming a first package component from a continuous blister web of formable material to which wireless identification devices have been pre-mounted in predetermined positions by molding a cavity and cavity opening and separating the first package component from the moldable blister web such that it has an predetermined outer size, wherein the cavity and cavity opening are configured to accept a medical article for packaging, and wherein the step of forming further comprises molding the cavity and cavity opening such that the pre-mounted wireless identification device for the formed first package component will have a predetermined position in relation to a medical article packaged in the cavity; and
forming a second package component;
attaching the second package component to the first package component to seal the cavity opening, thereby packaging a medical article in a blister pack.

14. The method for packaging and wirelessly identifying a medical article in a blister pack of claim 10, wherein the step of molding the cavity comprises thermoforming the cavity from the moldable blister web.

15. The method for packaging and wirelessly identifying a medical article in a blister pack of claim 10, wherein the step of molding the cavity comprises cold forming the cavity from the moldable blister web.

16. The method for packaging and wirelessly identifying a medical article in a blister pack of claim 10, wherein the step of forming a second package component comprises forming a second cavity from a second moldable blister web of material in which no wireless identification devices have been pre-mounted, the second cavity being configured to accept a medical device such that when assembled, the first and second package components of the blister pack form a clam shell package about a medical article.

17. A method for forming a web of blister packaging and wirelessly identifying material for use in forming blister packs about medical articles that also provide an identification device, the method comprising:
depositing a series of spaced-apart identification antenna traces along a length of a moldable blister web of packaging material, the blister web having a width and length selected to support the manufacture of an order for multiple blister packs for medical articles, the location of the identification antenna traces selected so that when the blister web is formed into blister packs, each identification antenna trace will be located in a predetermined position in relation to a reference point on the blister pack formed from the blister web;
mounting a wireless identification circuit device in electrical contact with each of the antenna traces on the moldable blister web of packaging material to form complete wireless identification devices at each location; and
storing the blister web of blister packaging and wirelessly identifying material in a configuration useful for storing, transporting, and manufacturing.

18. The method for forming a blister web of blister packaging and wirelessly identifying material for use in forming blister packs about medical articles that also provide an identification device of claim 17, wherein the steps of depositing antenna traces and mounting a wireless identification circuit at each antenna trace comprises depositing RFID antenna traces and mounting RFID identification circuits.
